(19) United States
(12) Patent Application Publication
(10) Pub. No.: US 2009/0140877 A1
(43) Pub. Date: Jun. 4, 2009

(54) REMOTE CONTROLLER

(75) Inventors: Cheng-Yung TENG, Taipei County (TW); Li-Jieu Hsu, Taipei City (TW)

Correspondence Address: Muncy, Geissler, Olds & Lowe, PLLC, P.O. BOX 1364, FAIRFAX, VA, 22038-1364, US

(73) Assignee: PRINCETON TECHNOLOGY CORPORATION

(21) Appl. No.: 12/100,208

(22) Filed: Apr. 9, 2008

(30) Foreign Application Priority Data
Dec. 4, 2007 (TW) 096220559

(51) Int. Cl. G05B 19/02

(52) U.S. Cl. 340/825.22

(57) ABSTRACT

A remote controller including buttons, an input module including resistors and switches, and a control module including a determining module, a storage module, and a modulation module. Each resistor is coupled to a power source and provides a current path corresponding to one button. The switches are coupled to the resistors. The corresponding switch provides the corresponding current path when one button is pushed. The input module accords with the corresponding current path to generate an input signal. The control module generates an output signal according to the input signal. When the input module transmits the input signal, the determining module obtains the pushed button according to the input signal and generates a determining signal according to the obtained result. The storage module generates a control signal according to the determining signal. The modulation module modulates the control signal to generate the output signal.

### BACKGROUND OF THE INVENTION

1. Field of the Invention

The invention relates to a remote controller, and more particularly to a remote controller which reduces the pin amount of a control IC.

2. Description of the Related Art

Remote controller functions have become increasingly powerful in recent years. Accordingly, the pin amounts of remote controllers have increased along with the volume of integrated circuits (ICs) therein. Thus, packaging costs have increased. Additionally, with volume of control ICs increasing, volume of the remote controllers have also increased.

FIG. 1 is a schematic diagram of a conventional remote controller. The remote controller 10 comprises a control IC 12. The control IC 12 is directly controlled by buttons. Each of the buttons (not shown) corresponds to one of switches SW₁˜SW₆₄. When one button is pushed by a user, the corresponding switch is turned on such that an input signal is generated and transmitted to a logic circuit 14. The logic circuit 14 encodes or decodes the input signal. The logic circuit 14 checks a table to select a corresponding control code stored in a storage module 16. The modulation module 18 modulates the control code to generate an output signal S_{OUT}. An output module 19 outputs the output signal S_{OUT}. If the remote controller 10 comprises 64 buttons, the control IC 12 must comprise 64 pins for receiving signals. The conventional remote controller requires a large amount of pins such that the packaging procedure of the control IC 12 is complex. Thus, the control IC 12 is costly.

FIG. 2 is a schematic diagram of another conventional remote controller. The structure of the remote controller 20 is a scan button structure. If the remote controller 20 comprises 64 buttons B₁˜B₆₄, the internal control IC 22 comprises 16 pins corresponding to the buttons B₁˜B₆₄. Although the pin amount of the internal control IC 22 is reduced, user requirement for even lighter and thinner profiles cannot been satisfied. Thus, when function and button amounts of the remote controller are maintained, reducing the pin amount of the control IC is important for reducing the volume of the remote controller.

### BRIEF SUMMARY OF THE INVENTION

Remote controllers are provided. An exemplary embodiment of a remote controller comprises a plurality of buttons, an input module, and a control module. The input module comprises a plurality of resistors and a plurality of switches. The resistors are coupled to a power source. Each resistor provides a current path corresponding to one of the buttons. The switches are coupled to the resistors. The corresponding switch provides the corresponding current path when one button is pushed. The input module accords with the corresponding current path to obtain power provided by the power source and generate an input signal. The control module is coupled to the input module and generates an output signal according to the input signal. The control module comprises a determining module, a storage module, and a modulation module. The determining module is coupled to the input module. When the input module transmits the input signal, the determining module obtains the pushed button according to the input signal and generates a determining signal according to the obtained result. The storage module is coupled to the determining module and generates a control signal according to the determining signal. The modulation module is coupled to the storage module and modulates the control signal to generate the output signal.

A detailed description is given in the following embodiments with reference to the accompanying drawings.

### BRIEF DESCRIPTION OF THE DRAWINGS

The invention can be more fully understood by referring to the following detailed description and examples with references made to the accompanying drawings, wherein:

FIG. 1 is a schematic diagram of a conventional remote controller;

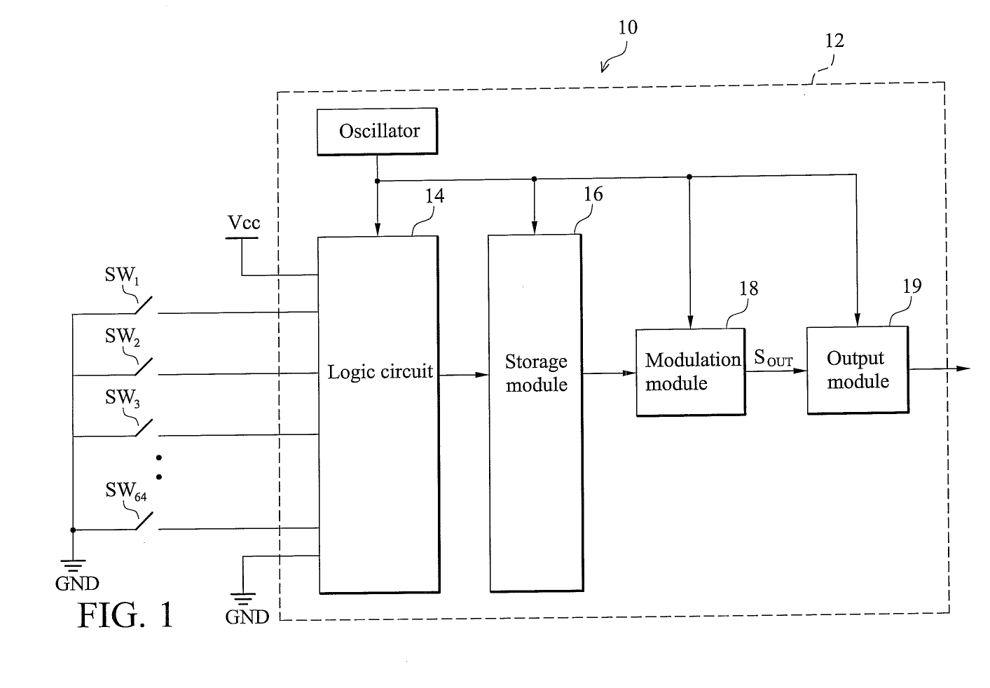

FIG. 2 is a schematic diagram of another conventional remote controller;

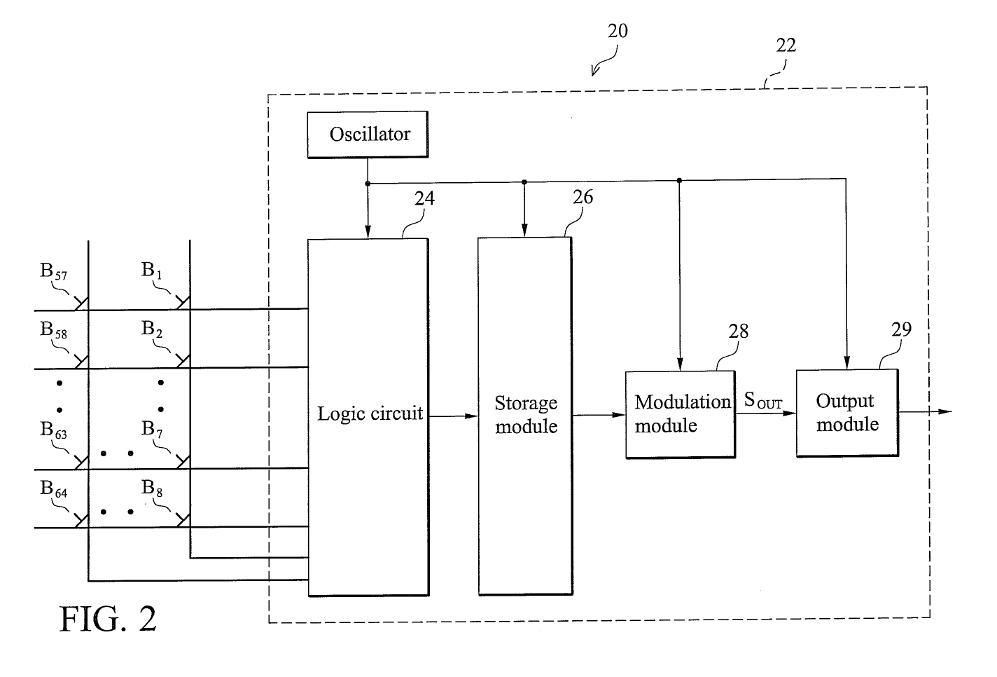

FIG. 3 is a schematic diagram of an exemplary embodiment of a remote controller; and

FIG. 4 is a schematic diagram of another exemplary embodiment of the remote controller.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

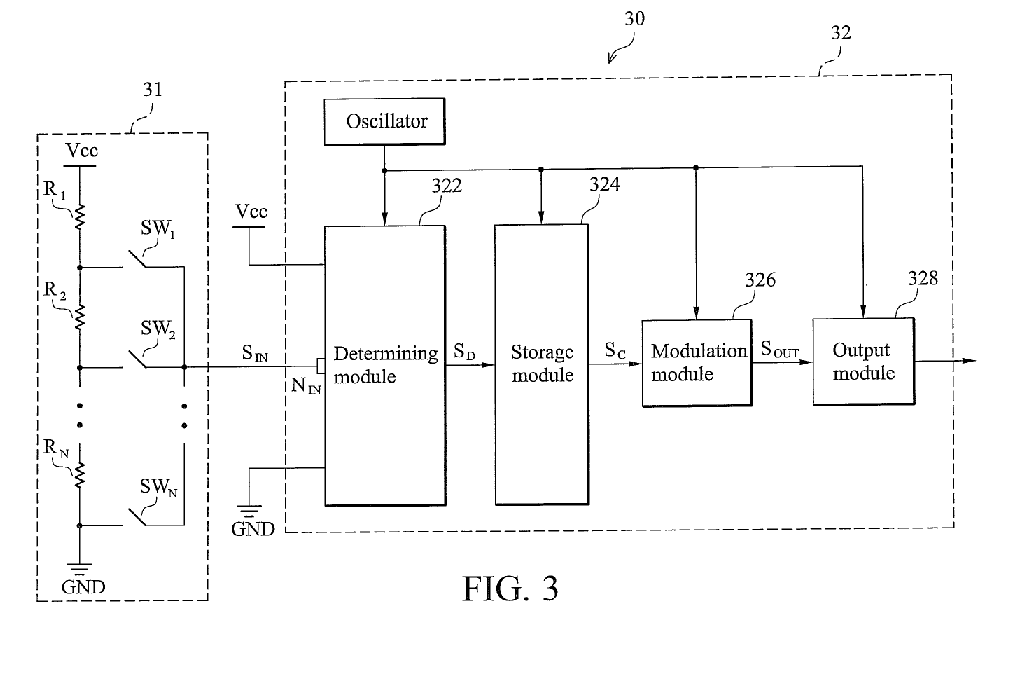

FIG. 3 is a schematic diagram of an exemplary embodiment of a remote controller. The remote controller 30 effectively reduces the pin amount of the control IC such that the volume and the cost of the remote controller 30 are reduced. The remote controller 30 comprises a plurality of buttons (not shown), an input module 31, and a control module 32. The input module 31 comprises resistors R₁˜R_{N} and switches SW₁˜SW_{N}. The resistors R₁˜R_{N} are coupled to a power source for receiving power Vcc. Each of the resistors R₁˜R_{N} provides a current path corresponding to one of the buttons. The switches SW₁˜SW_{N} are coupled to the resistors R₁˜R_{N}. When one of the buttons is pushed, the corresponding switch provides the corresponding current path. In other words, when one button is pushed, the corresponding switch is turned on. Thus, one current path controlled by the corresponding switch is tamed on. The input module 31 accords with the corresponding current path to obtain power Vcc provided by the power source and generate an input signal S_{IN}.

The control module 32 is coupled to the input module 31 and generates an output signal S_{OUT} according to the input signal S_{IN}. The control module 32 comprises a determining module 322, a storage module 324, and a modulation module 326. The determining module 322 is coupled to the input module 31. When the input module 31 transmits the input signal S_{IN}, the determining module 322 obtains the pushed button according to the input signal S_{IN} and generates a determining signal S_{D} according to the obtained result. The storage module 324 is coupled to the determining module 322 and generates a control signal S_{C} according to the determining signal S_{D}. The modulation module 326 is coupled to the storage module 324 and modulates the control signal S_{C} to generate the output signal S_{OUT}. The control module 32 further comprises an output module 328 and an oscillator OSC. The output module 328 is coupled to the modulation module 326 and utilizes a wireless method to transmit the output signal S_{OUT}. The oscillator OSC provides operation frequency required by the control module 32. In one embodiment, the control module 32 is an integrated circuit.

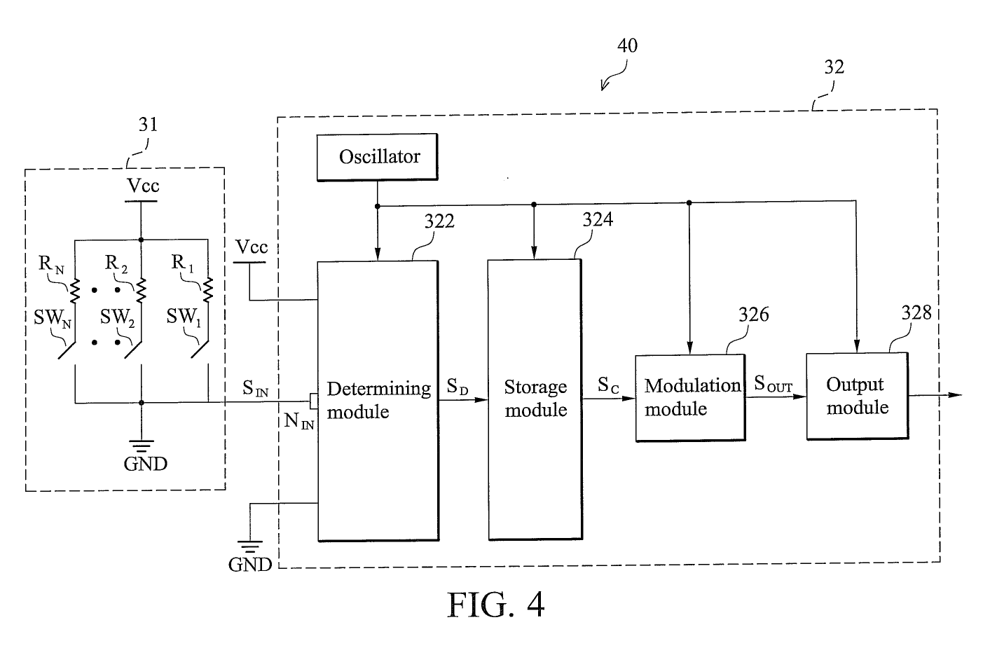

FIG. 4 is a schematic diagram of another exemplary embodiment of the remote controller. The resistors R₁˜R_{N} of the input module 31 are connected in parallel or in series. Referring to FIG. 3, the resistors R₁˜R_{N} are connected in parallel. Referring to FIG. 4, the resistors R₁˜R_{N} are connected in series.

The determining module 322 further comprises an input terminal N_{IN} coupled to the input module 31 for receiving the input signal S_{IN}. The input terminal N_{IN} is a general input/output (GIO) pin.

The input signal S_{IN} comprises a current value. The determining signal S_{D} comprises a control code. The determining module 322 obtains the pushed button according to the current value and generates the control code according to the obtained result.

In one embodiment, the storage module 324 is a read only memory (ROM). The storage module 324 stores a plurality of preset current values and a plurality of preset control codes. Each of the preset current values corresponds to one of the preset control codes. Each of the preset current values corresponds to one of the buttons.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A remote controller, comprising:
a plurality of buttons;
an input module comprising:
a plurality of resistors coupled to a power source, wherein each resistor provides a current path corresponding to one of the buttons; and
a plurality of switches coupled to the resistors, wherein the corresponding switch provides the corresponding current path when one button is pushed, and wherein the input module accords with the corresponding current path to obtain power provided by the power source and generate an input signal; and
a control module coupled to the input module, generating an output signal according to the input signal, and comprising:
a determining module coupled to the input module, wherein when the input module transmits the input signal, the determining module obtains the pushed button according to the input signal and generates a determining signal according to the obtained result;
a storage module coupled to the determining module and generating a control signal according to the determining signal; and
a modulation module coupled to the storage module and modulating the control signal to generate the output signal.

2. The remote controller as claimed in claim 1, wherein the resistors are connected in parallel or in series.

3. The remote controller as claimed in claim 1, wherein the determining module further comprises an input terminal coupled to the input module for receiving the input signal.

4. The remote controller as claimed in claim 3, wherein the input terminal is a general input/output (GIO) pin.

5. The remote controller as claimed in claim 4, wherein the input signal comprises a current value, the determining signal comprises a control code, the determining module obtains the pushed button according to the current value and generates the control code according to the obtained result.

6. The remote controller as claimed in claim 5, wherein the storage module stores a plurality of preset current values and a plurality of preset control codes, and wherein each of the preset current values corresponds to one of the preset control codes.

7. The remote controller as claimed in claim 6, wherein each of the preset current values corresponds to one of the buttons.

8. The remote controller as claimed in claim 7, wherein the storage module is a read only memory (ROM).

9. The remote controller as claimed in claim 1, wherein the control module further comprises an output module for transmitting the output signal.

10. The remote controller as claimed in claim 1, wherein the control module further comprises an oscillator for providing operation frequency required by the control module.

11. The remote controller as claimed in claim 1, wherein the output module utilizes a wireless method to transmit the output signal.

12. The remote controller as claimed in claim 1, wherein the control module is an integrated circuit.
